(19) United States
(12) Patent Application Publication
(10) Pub. No.: US 2018/0074644 A1
(43) Pub. Date: Mar. 15, 2018

(54) ELECTRONIC APPARATUS AND METHOD OF CONTROLLING THE SAME

(71) Applicant: CANON KABUSHIKI KAISHA, Tokyo (JP)

(72) Inventor: Atsushi Ichihara, Yokohama-shi (JP)

(21) Appl. No.: 15/696,789

(22) Filed: Sep. 6, 2017

(30) Foreign Application Priority Data
Sep. 9, 2016 (JP) 2016-177031

(51) Int. Cl. G06F 3/041; G06F 3/044; G09G 3/34; G09G 3/36

(52) U.S. Cl. CPC G06F 3/0416; G06F 3/044; G09G 3/3406; G09G 2354/00; G09G 2310/08; G09G 2320/064; G09G 3/36

(57) ABSTRACT

A backlight control unit applies to a backlight of a display a backlight current based on a pulse-width modulation signal. A touch panel control unit detects rising and falling edges of the PWM signal, applies a capacity detection signal to a touch panel during an on-period or off-period of the backlight current, and detects a touch operation on the touch panel 19. The touch panel control unit calculates the presence/absence and coordinates of a touch operation from sensor output signals from the touch panel.

### BACKGROUND

### Field

The present disclosure relates to electronic apparatuses including a touch panel disposed on top of a display screen of a display unit and methods of controlling the same.

### Description of the Related Art

Recent mobile communication terminals, such as smartphones and digital cameras include a display monitor, such as a liquid crystal monitor, with a size close to the device's housing size in order to improve visibility of the display. A liquid crystal monitor including a touch panel instead of a mechanical operation member, such as buttons, has been used since it enables users to easily perform various operations.

Such a touch panel is disposed on top of the liquid crystal monitor with glass or a film therebetween, so touch sensors of the touch panel are easily affected by noise generated during the driving of a liquid crystal panel, etc. This can, for example, change output signals of the touch sensors to lead to an erroneous operation.

Japanese Patent Application Laid-Open No. 2012-048295 discusses a technique of assigning display operation blanking periods of a liquid crystal monitor to touch detection periods of a touch sensor to reduce noise generated by the driving of gates of thin-film-transistors (TFTs) of pixels.

The conventional technique discussed in Japanese Patent Application Laid-Open No. 2012-048295 is effective for noise generated by the driving of display of a liquid crystal panel, but is not effective for noise generated by the backlight luminance control for controlling the luminance of the display. The backlight of the liquid crystal panel mainly uses white light emitting diodes, and the luminance of light emitted from the white light emitting diodes is controlled using pulse-width modulation (PWM). This is because the method in which the driving current is direct current and the luminance is controlled by controlling the amplitude of the driving current causes a change in tones of output colors.

In the PWM control, the driving current (backlight current) for driving the white light emitting diodes is periodically turned on, and turning on and off the driving current generates noise to affect the touch sensors. The effect on the touch sensors can be significant, especially when the capacity detection cycle of the touch panel and the driving frequency of the backlight current are consistent.

### SUMMARY

The present disclosure is directed to a technique for reducing adverse effects on the detection of a touch on a touch panel from a liquid crystal panel including a backlight controlled using pulse-width modulation (PWM).

According to an aspect of the present disclosure, an electronic apparatus includes a display including a backlight, a backlight control unit configured to drive the backlight with a backlight current based on a pulse-width modulation signal, a touch panel disposed on top of a screen of the display, and a touch panel control unit configured to detect a touch operation on the touch panel during a predetermined period to avoid a rising timing and a falling timing of the backlight current.

Further features will become apparent from the following description of exemplary embodiments with reference to the attached drawings.

### BRIEF DESCRIPTION OF THE DRAWINGS

FIG. 1 is a block diagram schematically illustrating a configuration according to a first exemplary embodiment.

FIG. 2 is a flow chart illustrating an operation according to the first exemplary embodiment.

FIGS. 3A to 3C are each a timing chart illustrating an example of the operation according to the first exemplary embodiment.

FIG. 4 is a flow chart illustrating an operation according to a second exemplary embodiment.

FIGS. 5A to 5C are each a timing chart illustrating an example of the operation according to the second exemplary embodiment.

FIG. 6 is a block diagram schematically illustrating a configuration according to a third exemplary embodiment.

FIG. 7 is a flow chart illustrating an operation according to the third exemplary embodiment.

FIGS. 8A to 8E are each a timing chart illustrating an example of the operation according to the third exemplary embodiment.

FIG. 9 is a flow chart illustrating an operation according to a fourth exemplary embodiment.

FIGS. 10A to 10E are each a timing chart illustrating an example of the operation according to the fourth exemplary embodiment.

### DESCRIPTION OF THE EMBODIMENTS

Exemplary embodiments will be described in detail below with reference to the accompanying drawings. The following exemplary embodiment is merely one example and can be appropriately modified or changed depending on individual constructions and various conditions of apparatuses to which the present disclosure is applied. Thus, the following exemplary embodiments are not seen to be limiting.

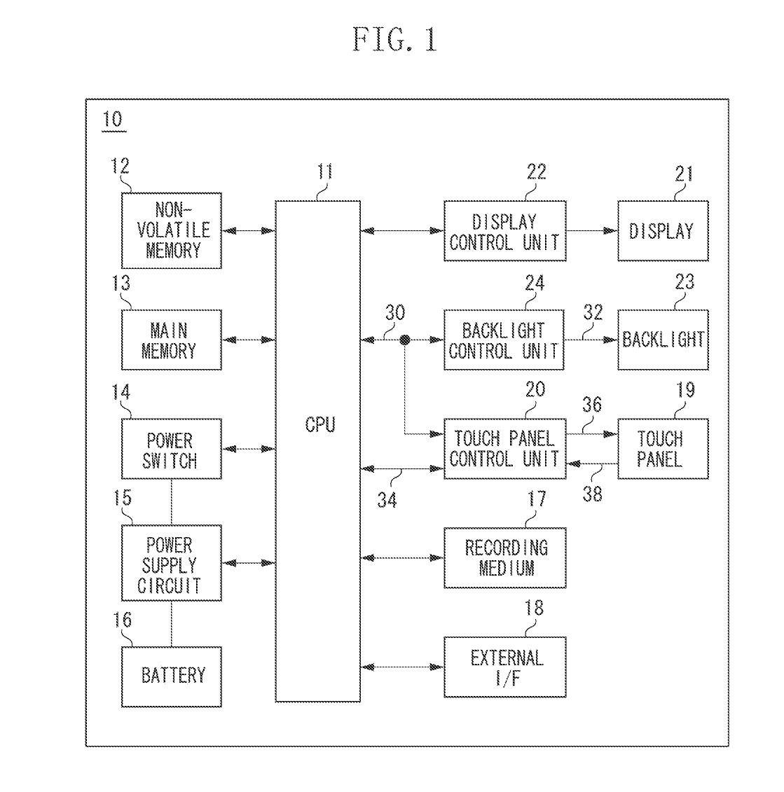

The following describes a first exemplary embodiment. FIG. 1 is a block diagram schematically illustrating the configuration of an electronic apparatus according to the first exemplary embodiment.

In an electronic apparatus 10 illustrated in FIG. 1, a central processing unit (CPU) 11 is a microcomputer configured to control the electronic apparatus 10. A non-volatile memory 12 stores various programs for realizing control functions of the CPU 11. A main memory 13 includes, for example, a random access memory (RAM). The CPU 11 controls the respective components of the electronic apparatus 10 according to a program stored in the non-volatile memory 12 using the main memory 13 as a work memory.

In the case where a camera function (not illustrated) including an image capturing element and a lens is included, the main memory 13 also operates as an image memory for storing captured still images or moving images. The main memory 13 includes sufficient storage capacity to store a predetermined number of still images or a predetermined amount of time of moving images.

A power switch 14 is a switch for controlling the application of power to the electronic apparatus 10. A power supply circuit 15 is a circuit for supplying power to respective blocks of the electronic apparatus 10. A battery 16 functions as a power source of the electronic apparatus 10. The power source is not limited to the battery 16 and can be, for example, an alternating current (AC) adapter.

The power supply circuit 15 supplies power to the respective blocks of the electronic apparatus 10 when the power switch 14 is on. The power supply circuit 15 stops the supply of power to a predetermined block according to a control signal, which is an instruction from the CPU 11, to change to a power-saving mode, and restarts the supply of power based on a control signal that is an instruction to recover.

A recording medium 17 is a memory card that is insertable into and removable from the electronic apparatus 10.

An external interface (I/F) 18 is an interface unit configured to enable connection to an external device such as a universal serial bus (USB) or high-definition multimedia interface (HDMI®).

A touch panel 19 includes a plurality of electrostatic capacitive touch sensors, and generates a capacity between the touch panel 19 and a conductive object, such as a user's finger, in response to a touch to detect the presence/absence and coordinates/region of a touch. The touch sensors are disposed, for example, in a two-dimensional, planar arrangement on the touch panel 19. A touch panel control unit 20 is a controller circuit configured to control the touch panel 19. The touch panel control unit 20 transmits a capacity detection signal to the touch panel 19, calculates the coordinates/region of a touch based on outputs from the touch sensors of the touch panel 19, and transmits the calculated coordinates/region to the CPU 11. In this way, the CPU 11 receives details of a user operation performed on the touch panel 19.

A display 21 includes, for example, a liquid crystal panel and is used as a display monitor. The touch panel 19 is disposed on top of a screen of the display 21. A display control unit 22 is a controller circuit configured to process display data and display control signals from the CPU 11 and display on the display 21 images corresponding to the display data. The backlight 23 of the display 21 includes, for example, a white light emitting diode. A backlight control unit 24 is a controller circuit configured to control the luminance of the backlight 23 according to the control performed by the CPU 11.

The touch panel 19 and the display 21 can be an in-cell touch panel display in which display elements of the display 21 and electrodes of the touch panel 19 are integrated with no separator therebetween. In the in-cell touch panel display, the distance between the touch sensors of the touch panel 19 and the backlight 23 is small, so the touch sensors are easily affected by noise from the backlight 23.

The following describes capacity detection control according to the present exemplary embodiment for reducing the effect of noise from the backlight 23 on the touch sensors of the touch panel 19.

The CPU 11 supplies to the backlight control unit 24 a pulse-width modulation (PWM) signal 30 for controlling the luminance of the backlight 23. The backlight control unit 24 supplies to the light-emitting diode (LED) of the backlight 23 a constant-amplitude backlight current 32, which is turned on and off in synchronization with the PWM signal 30. The luminance of the backlight 23 is controlled by controlling the duty cycle of the PWM signal 30. The CPU 11 also supplies the PWM signal 30 to the touch panel control unit 20.

The CPU 11 transmits, via a bus 34, to the touch panel control unit 20 a command that is an instruction to start/stop the status detection of a touch on the touch panel 19. The detection start command desirably contains two or more of data that indicates the length of the cycle period of the PWM signal 30, data that indicates the length of an on-period, and data that indicates the length of an off-period. These pieces of data are supplied to the touch panel control unit 20 so that the touch panel control unit 20 can execute the capacity detection of the touch sensors of the touch panel 19 at predetermined timings to avoid rising and falling edges of the backlight current 32. The touch panel control unit 20 calculates the presence/absence and coordinates/region of a touch on the touch panel 19 based on a command from the CPU 11 and transmits the calculation result to the CPU 11 via the bus 34.

In the present exemplary embodiment, the touch panel control unit 20 supplies to the touch panel 19 a capacity detection signal 36 to provide an instruction to read the capacities of the touch sensors of the touch panel 19 at predetermined timings to avoid the rising and falling edges of the backlight current 32. Details thereof will be described below. The touch panel 19 outputs to the touch panel control unit 20 a sensor output signal 38, which indicates a capacity value of each of the touch sensors, in response to the capacity detection signal 36. The touch panel control unit 20 calculates the sensor output signals 38 of the touch panel 19 to calculate the presence/absence and coordinates/region of a touch and transmits the calculation result to the CPU 11 via the bus 34.

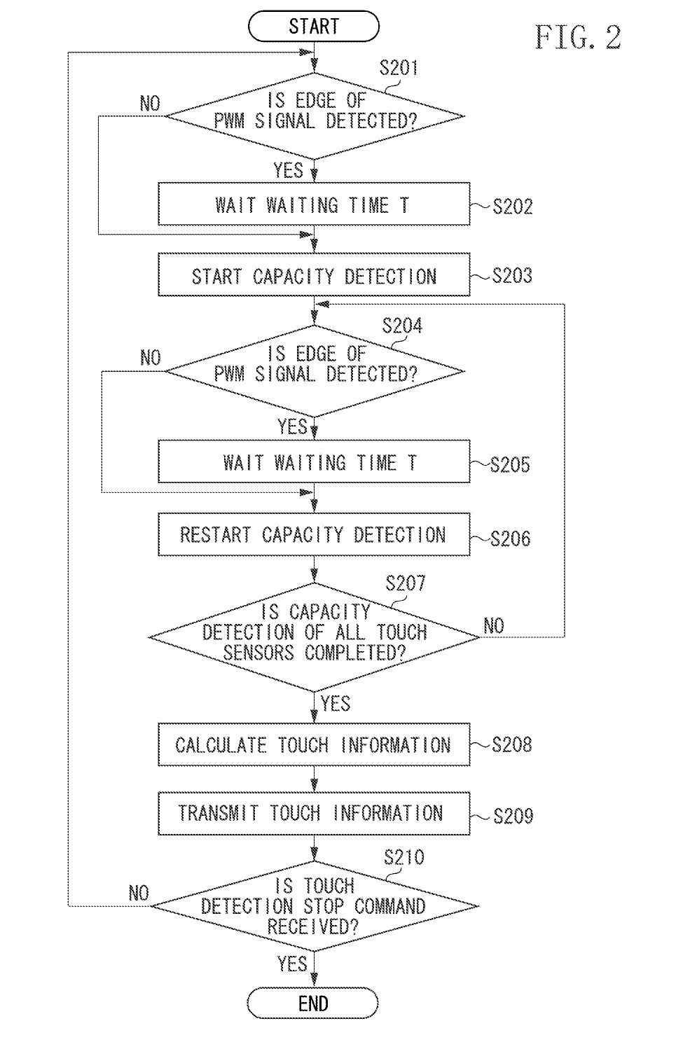

FIG. 2 is a flow chart illustrating an operation of the capacity detection control for avoiding noise from the backlight 23 with respect to the touch panel 19. Firmware or a program for realizing the process illustrated in FIG. 2 is installed in the touch panel control unit 20. The functions of the touch panel control unit 20 can be realized by a program running on the CPU 11. In this case, the CPU 11 reads the program for realizing the process illustrated in FIG. 2 from the non-volatile memory 12 and executes the program to realize the functions of the touch panel control unit 20, or loads the program into the touch panel control unit 20 to cause the touch panel control unit 20 to execute the program.

The CPU 11 supplies the PWM signal 30 to the backlight control unit 24 to turn on the backlight 23, and transmits display image data to the display control unit 22 to display images on the display 21. The CPU 11 transmits a touch detection start command to the touch panel control unit 20 via the bus 34 to change the touch panel control unit 20 to an activated state. In the activated state, the touch panel control unit 20 realizes the process illustrated in FIG. 2 under the control performed by the CPU 11.

In step S201, the touch panel control unit 20 determines whether a rising edge or falling edge of the PWM signal 30 is detected. If a rising edge or falling edge of the PWM signal 30 is detected (YES in step S201), the processing proceeds to step S202. If neither a rising edge nor falling edge of the PWM signal 30 is detected (NO in step S201), the processing proceeds to step S203.

In step S202, the touch panel control unit 20 waits a predetermined time T for the backlight current 32 to be turned on or off.

In step S203, the touch panel control unit 20 transmits the capacity detection signal 36 to the touch panel 19 to start detecting the capacity of the touch panel 19.

In step S204, the touch panel control unit 20 determines whether a rising edge or falling edge of the PWM signal 30 is detected. If a rising edge or falling edge of the PWM signal 30 is detected (YES in step S204), the processing proceeds to step S205. If neither a rising edge nor falling edge of the PWM signal 30 is detected (NO in step S204), the processing proceeds to step S206.

In step S205, the touch panel control unit 20 stops the capacity detection signal 36 and waits the predetermined time T for the backlight current 32 to be turned on or off.

In step S206, the touch panel control unit 20 transmits the capacity detection signal 36 to the touch panel 19 to restart detecting the capacity of the touch panel 19.

In step S207, the touch panel control unit 20 determines whether the capacity detection signal 36 is transmitted to all the touch sensors of the touch panel 19 and the sensor output signal 38 is received from all the touch sensors. If the capacity detection of all the touch sensors is completed (YES in step S207), the processing proceeds to step S208. If the capacity detection of all the touch sensors is not completed (NO in step S207), the processing returns to step S204.

In step S208, the touch panel control unit 20 calculates the sensor output signals 38 of all the touch sensors and determines the presence/absence and coordinates/region of a touch.

In step S209, the touch panel control unit 20 transmits to the CPU 11 the result of the calculation performed in step S208. The CPU 11 executes control in response to the detected touch based on the data from the touch panel control unit 20.

In step S210, the touch panel control unit 20 determines whether a touch detection stop command is received from the CPU 11. If a touch detection stop command is received (YES in step S210), the process illustrated in FIG. 2 ends. If no touch detection stop command is received (NO in step S210), the processing returns to step S201 to continue the process of detecting the capacity of the touch panel 19.

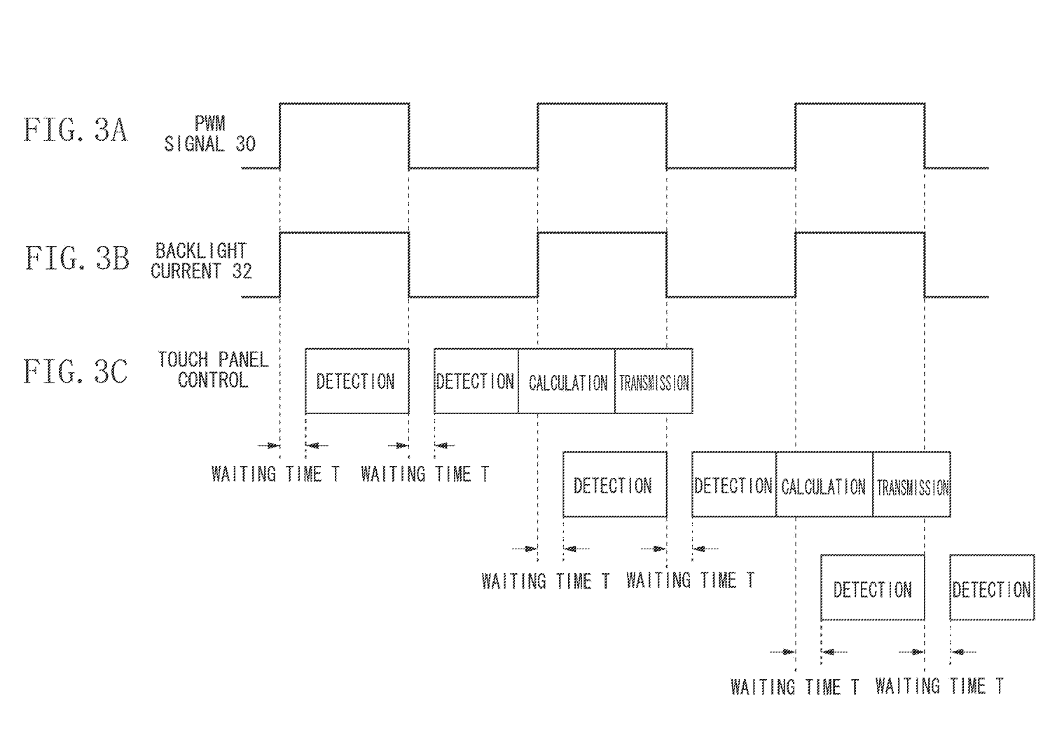

FIGS. 3A to 3C illustrate an example of the timings with respect to the capacity detection process illustrated in FIG. 2. FIG. 3A illustrates the waveform of the PWM signal 30. FIG. 3B illustrates the waveform of the backlight current 32. FIG. 3C illustrates details of the operation of the touch panel control unit 20.

The backlight control unit 24 supplies to the backlight 23 the backlight current 32 (FIG. 3B) synchronized with the PWM signal 30 according to the PWM signal 30 (FIG. 3A) from the CPU 11. The backlight current 32 is repeatedly turned on and off in synchronization with the PWM signal 30.

If the touch panel control unit 20 detects a rising edge of the PWM signal 30, the touch panel control unit 20 waits the predetermined time T and then outputs the capacity detection signal 36 to the touch panel 19 to detect the capacities of the sensors of the touch panel 19. The waiting time T is set to a short time within the on-period of the PWM signal 30 (backlight current 32) such that the detection of a touch on the touch panel 19 is not affected by noise originating from a rising edge.

If the touch panel control unit 20 detects a falling edge of the PWM signal 30 during the capacity detection of the touch panel 19, the touch panel control unit 20 stops the capacity detection of the touch panel 19. Then, the touch panel control unit 20 waits the predetermined time T and thereafter restarts the capacity detection of the touch panel 19. The touch panel control unit 20 repeats the foregoing operation until the capacity detection of all the touch sensors of the touch panel 19 is completed.

In the case where the on- and off-periods of the PWM signal 30 can be determined from data added to a touch detection command, the touch panel control unit 20 can stop the capacity detection of the touch panel 19 immediately before rising and falling edges of the backlight current 32.

If the capacity detection of all the touch sensors of the touch panel 19 is completed, the touch panel control unit 20 performs the above-described calculation to calculate the presence/absence and coordinates/region of a touch and transmits the calculation result to the CPU 11. In parallel with the calculation and transmission, the touch panel control unit 20 performs detection of a rising edge or falling edge of the PWM signal 30 for the second capacity detection of the touch panel 19. If a rising edge or falling edge of the PWM signal 30 is detected, the touch panel control unit 20 waits the predetermined time T as described above and then starts the capacity detection of the touch panel 19.

According to the present exemplary embodiment, the capacity detection of the touch panel 19 is executed at predetermined timings to avoid the effect of current fluctuation noise originating from the rising and falling edges of the backlight current 32. This prevents erroneous detection of the touch panel 19.

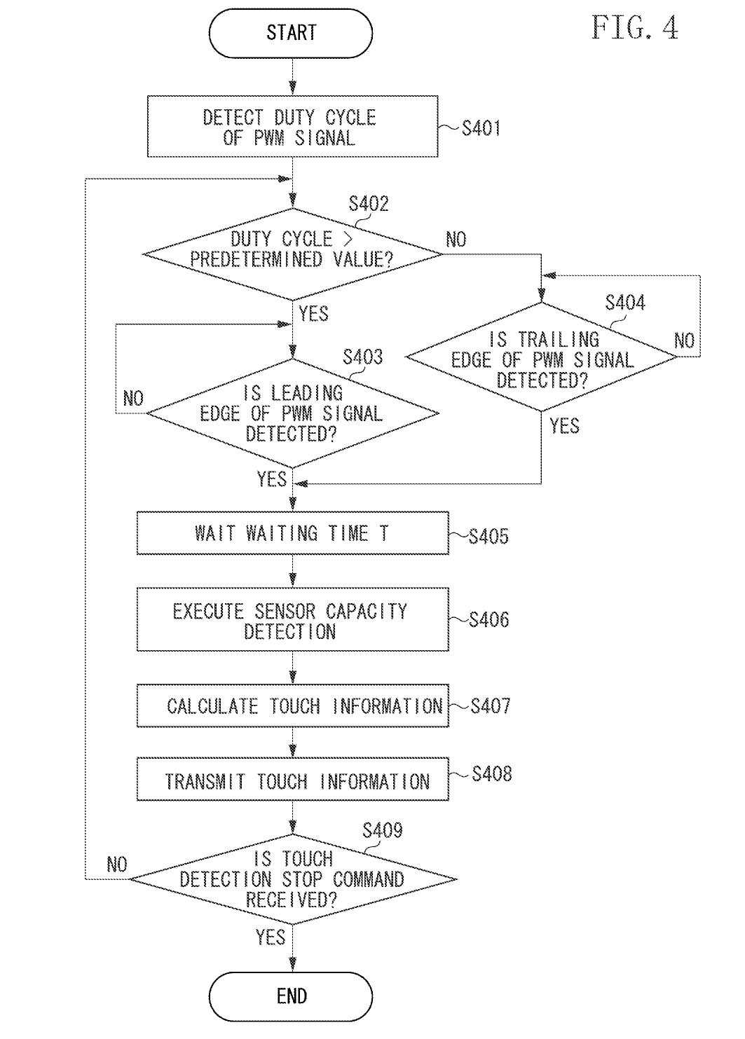

The following describes a second exemplary embodiment. FIG. 4 is a flow chart illustrating another operation of the touch panel control unit 20. Firmware or a program for realizing the process illustrated in FIG. 4 is installed in the touch panel control unit 20. The functions of the touch panel control unit 20 can be realized by a program running on the CPU 11. In this case, the CPU 11 reads the program for realizing the process illustrated in FIG. 4 from the non-volatile memory 12 and executes the program to realize the functions of the touch panel control unit 20, or loads the program into the touch panel control unit 20 to cause the touch panel control unit 20 to execute the program.

The CPU 11 supplies the PWM signal 30 to the backlight control unit 24 to turn on the backlight 23, and transmits display image data to the display control unit 22 to display images on the display 21. The CPU 11 transmits a touch detection start command to the touch panel control unit 20 via the bus 34 to change the touch panel control unit 20 to an activated state. In the activated state, the touch panel control unit 20 realizes the process illustrated in FIG. 4 under the control performed by the CPU 11.

In step S401, the touch panel control unit 20 detects the duty cycle of the PWM signal 30. In step S402, the touch panel control unit 20 determines whether the duty cycle of the PWM signal 30 detected in step S401 is greater than a predetermined value. If the detected duty cycle is greater than the predetermined value (in the present exemplary embodiment, 50%) (YES in step S402), the processing proceeds to step S403. If the detected duty cycle is less than or equal to the predetermined value (NO in step S402), the processing proceeds to step S404.

In step S403, the touch panel control unit 20 waits until a rising edge of the PWM signal 30 is detected. If a rising edge is detected (YES in step S403), the processing proceeds to step S405.

In step S404, the touch panel control unit 20 waits until a falling edge of the PWM signal 30 is detected. If a falling edge is detected (YES in step S404), the processing proceeds to step S405.

In step S405, the touch panel control unit 20 waits the predetermined time T with the output of the capacity detection signal 36 stopped to wait for the backlight current 32 to be turned on or off.

In step S406, the touch panel control unit 20 outputs the capacity detection signal 36 to the touch panel 19 to execute the capacity detection of the touch sensors of the touch panel 19. At this time, the touch panel control unit 20 sets the period of the capacity detection of the touch panel 19 sufficiently shorter than the cycle of the PWM signal 30.

In step S407, the touch panel control unit 20 calculates the sensor output signals 38 with respect to the capacity detection signal 36 to determine the presence/absence and coordinates/region of a touch. In step S408, the touch panel control unit 20 transmits the result of calculation performed in step S407 to the CPU 11. The CPU 11 executes control in response to the detected touch according to the data from the touch panel control unit 20.

In step S409, the touch panel control unit 20 determines whether a touch detection stop command is received from the CPU 11. If a touch detection stop command is received (YES in step S409), the process illustrated in FIG. 4 ends. If no touch detection stop command is received (NO in step S409), the processing returns to step S402, and the process of detecting the capacity of the touch panel 19 continues.

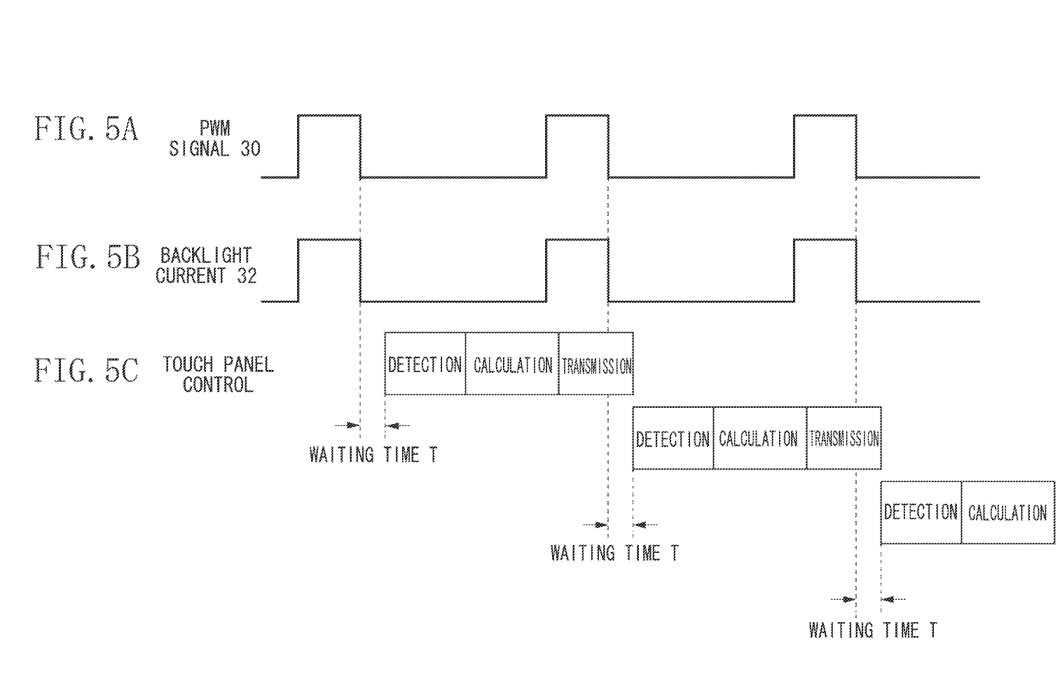

FIGS. 5A to 5C illustrate an example of the timings with respect to the capacity detection process illustrated in FIG. 4. FIG. 5A illustrates the waveform of the PWM signal 30. FIG. 5B illustrates the waveform of the backlight current 32. FIG. 5C illustrates details of the operation of the touch panel control unit 20.

The backlight control unit 24 supplies to the backlight 23 the backlight current 32 (FIG. 5B) synchronized with the PWM signal 30 according to the PWM signal 30 (FIG. 5A) from the CPU 11. The backlight current 32 is repeatedly turned on and off in synchronization with the PWM signal 30. The touch panel control unit 20 detects the duty cycle of the PWM signal 30 in step S401 and determines whether the duty cycle is greater than the predetermined value in step S402. FIGS. 5A to 5C illustrate an example of the timings in the case where the duty cycle is less than or equal to the predetermined value.

If a falling edge of the PWM signal 30 is detected, the touch panel control unit 20 waits the predetermined time T and thereafter outputs the capacity detection signal 36 to the touch panel 19 to perform the capacity detection of all the touch sensors of the touch panel 19. If the capacity detection of all the touch sensors is completed, the touch panel control unit 20 performs detection of a falling edge of the PWM signal 30 for the next capacity detection of the touch panel 19. In parallel with the falling edge detection, the touch panel control unit 20 calculates the presence/absence and coordinates/region of a touch from the sensor output signals 38 and transmits the calculation result to the CPU 11.

As described above, in the second exemplary embodiment, in the case where the duty cycle is less than or equal to the predetermined value, the touch panel control unit 20 intensively detects the capacities of all the touch sensors of the touch panel 19 during the off-period of the backlight current 32. In the case where the duty cycle is greater than the predetermined value, the touch panel control unit 20 intensively detects the capacities of all the touch sensors of the touch panel 19 during the on-period of the backlight current 32. This reduces the effect of noise originating from the rising and falling edges of the backlight current 32 on the capacity detection of the touch panel 19. In this way, the capacity detection of all the touch sensors of the touch panel 19 is not interrupted, and the detection of the presence/absence and coordinates/region of a touch on the touch panel 19 is more stably executed.

In a case where the touch detection start command contains data that indicates the duty cycle, the duty cycle detection (step S401) at the touch panel control unit 20 is not necessary.

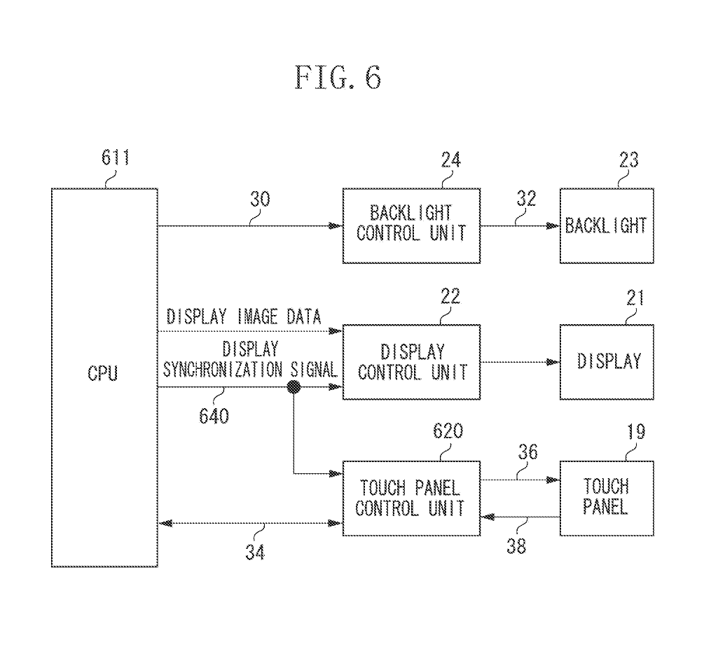

FIG. 6 is a block diagram schematically illustrating a configuration according to a third exemplary embodiment. In FIG. 6, portions that are changed from the first exemplary embodiment are illustrated. Components that are similar to those according to the exemplary embodiment illustrated in FIG. 1 have the same reference numerals. In the third exemplary embodiment illustrated in FIG. 6, a CPU 611 corresponding to the CPU 11 applies a display synchronization signal (horizontal synchronization signal and vertical synchronization signal) 640 supplied to the display control unit 22 to a touch panel control unit 620 corresponding to the touch panel control unit 20. The CPU 611 supplies just to the backlight control unit 24 a PWM signal 30 synchronized with a horizontal synchronization signal contained in the display synchronization signal 640 and with the same frequency as the frequency of the horizontal synchronization signal. These are the points that are different from the exemplary embodiment illustrated in FIG. 1.

In the present exemplary embodiment, the touch panel control unit 620 receives information about the PWM signal 30 and eventually the timing of the rising edges of the backlight current 32 from the horizontal synchronization signal contained in the display synchronization signal 640 from the CPU 611.

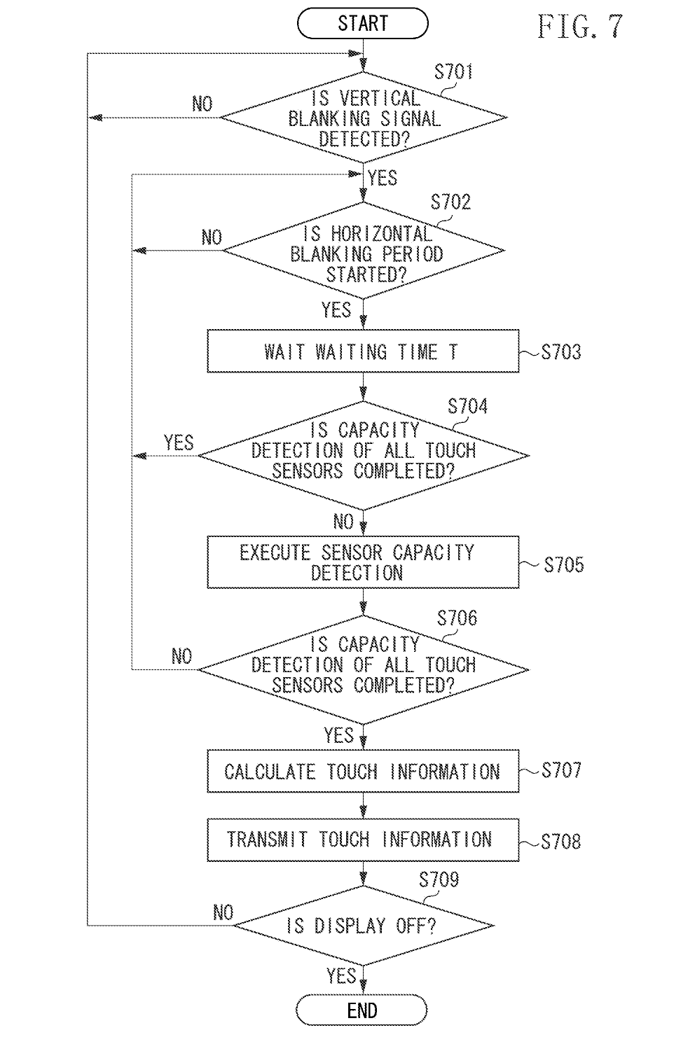

FIG. 7 is a flow chart illustrating an operation of the capacity detection of the touch panel 19 performed by the touch panel control unit 620. Firmware or a program for realizing the process illustrated in FIG. 7 is installed in the touch panel control unit 620. The functions of the touch panel control unit 620 can be realized by a program running on the CPU 611. In this case, the CPU 611 reads the program for realizing the process illustrated in FIG. 7 from the non-volatile memory 12 and executes the program to realize the functions of the touch panel control unit 620, or loads the program into the touch panel control unit 620 to cause the touch panel control unit 620 to execute the program.

The CPU 611 supplies the PWM signal 30 synchronized with the horizontal synchronization signal of the display synchronization signal 640 and with the same frequency as the frequency of the horizontal synchronization signal to the backlight control unit 24 to turn on the backlight 23. At the same time, the CPU 611 supplies display image data and the display synchronization signal 640 to the display control unit 22 to display images on the display 21. The CPU 611 transmits a touch detection start command to the touch panel control unit 620 via the bus 34 to change the touch panel control unit 620 to an activated state. In the activated state, the touch panel control unit 620 realizes the process illustrated in FIG. 7 under the control performed by the CPU 611.

In step S701, the touch panel control unit 620 waits for a vertical blanking signal of the display synchronization signal 640. Specifically, the touch panel control unit 620 waits for a start of one-frame display processing. If a vertical blanking signal is detected (YES in step S701), the processing proceeds to step S702.

In step S702, the touch panel control unit 620 performs edge detection of the horizontal synchronization signal to wait for a start of a horizontal blanking period. If a horizontal blanking period is started (YES in step S702), the processing proceeds to step S703.

In step S703, the touch panel control unit 620 waits the predetermined time T for the backlight current 32 to be turned on or off.

In step S704, the touch panel control unit 620 determines whether the capacity detection signal 36 is transmitted to all the touch sensors of the touch panel 19 and the sensor output signal 38 is received from all the touch sensors. If the capacity detection of all the touch sensors is completed (YES in step S704), the processing returns to step S702. If the capacity detection of all the touch sensors is not completed (NO in step S704), the processing proceeds to step S705.

In step S705, the touch panel control unit 620 transmits the capacity detection signal 36 to all the touch sensors of the touch panel 19 to detect the capacities of all the touch sensors. The touch panel control unit 620 performs the capacity detection of the touch panel 19 just on a region detectable within the horizontal blanking period, and if the horizontal blanking ends, the capacity detection of the touch panel 19 stops.

In step S706, the touch panel control unit 620 determines whether the capacity detection signal 36 is transmitted to all the sensors of the touch panel 19 and the sensor output signal 38 is received from all the sensors. If the capacity detection of all the sensors is completed (YES in step S706), the processing proceeds to step S707. If the capacity detection of all the touch sensors is not completed (NO in step S706), the processing returns to step S702.

In step S707, the touch panel control unit 620 calculates, based on the sensor output signals 38, the presence/absence and coordinates/region of a touch.

In step S708, the touch panel control unit 620 transmits the result of the calculation performed in step S707 to the CPU 611. The CPU 611 executes control in response to the detected touch based on the data from the touch panel control unit 620.

In step S709, the touch panel control unit 620 determines whether the display on the display 21 is off based on the display synchronization signal 640 or a touch detection stop command from the CPU 611. If the display is not off (NO in step S709), the processing returns to step S701. If the display is off (YES in step S709), the process illustrated in FIG. 7 ends. In the case where the display is to be off, the CPU 611 stops the output of the display synchronization signal 640 and supplies a touch detection stop command to the touch panel control unit 620.

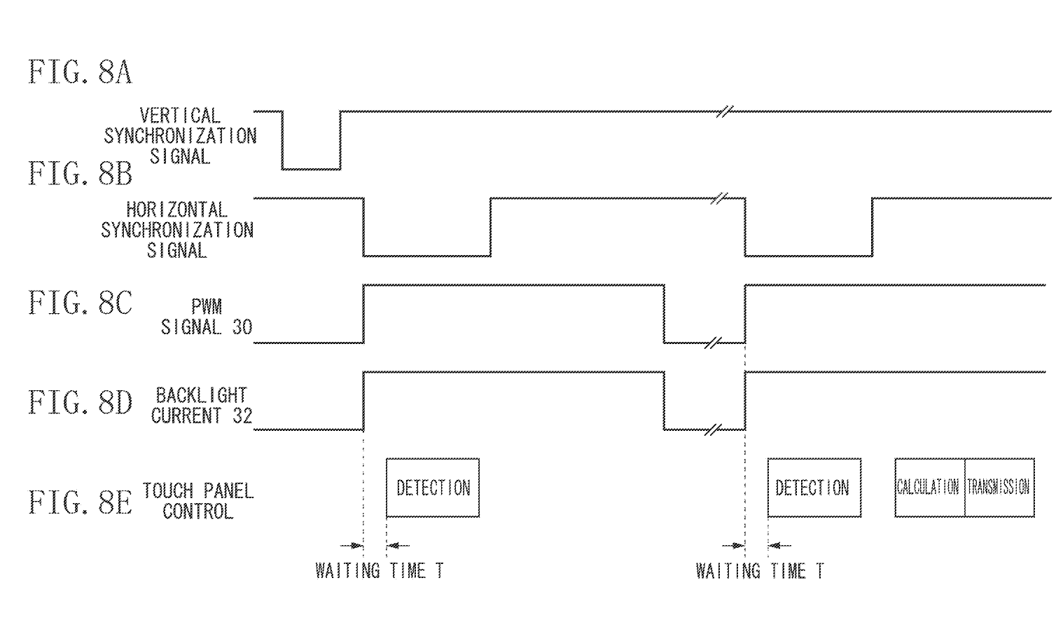

FIGS. 8A to 8E illustrate an example of the timings with respect to the capacity detection process illustrated in FIG. 7. FIG. 8A illustrates the vertical synchronization signal contained in the display synchronization signal. FIG. 8B illustrates the horizontal synchronization signal. FIG. 8C illustrates the waveform of the PWM signal 30. FIG. 8D illustrates the waveform of the backlight current 32. FIG. 8E illustrates details of the operation of the touch panel control unit 620.

The CPU 611 drives the PWM signal 30 with the same frequency as the frequency of the horizontal synchronization signal (FIG. 8B) of the display synchronization signal 640, and outputs the PWM signal 30 in synchronization with the horizontal synchronization signal.

The backlight control unit 24 supplies the backlight current 32 (FIG. 8D) synchronized with the PWM signal 30 to the backlight 23 based on the PWM signal 30 (FIG. 8C) from the CPU 611. The backlight current 32 is repeatedly turned on and off in synchronization with the PWM signal 30.

The touch panel control unit 620 detects an end of vertical blanking and a falling edge of the horizontal synchronization signal as described above. If the touch panel control unit 620 detects a start of the horizontal blanking period, the touch panel control unit 620 outputs the capacity detection signal 36 to the touch panel 19 after the predetermined time T and detects the capacity of the touch panel 19. During horizontal scans, the capacity detection of the touch panel 19 is repeatedly executed.

If the capacity detection of all the touch sensors is completed, the touch panel control unit 620 calculates the presence/absence and coordinates/region of a touch according to the sensor output signals 38 of all the touch sensors and transmits the calculation result to the CPU 611.

The touch panel control unit 620 detects a vertical blanking period for the next capacity detection of the touch panel 19. Thereafter, the touch panel control unit 620 repeats the same processing until an instruction to stop the touch detection is provided by the CPU 611.

In the present exemplary embodiment, the backlight current 32 is on during the horizontal blanking period. The touch sensor capacity detection is performed during the horizontal blanking period, so a touch operation is detected without being affected by current fluctuation noise originating from the rising or falling edges of the backlight current 32.

In FIG. 6, the CPU 611 supplies the display synchronization signal 640 to both the display control unit 22 and the touch panel control unit 620. Alternatively, the display control unit 22 can supply to the touch panel control unit 620 a control signal synchronized with the display synchronization signal 640 according to the display synchronization signal 640 from the CPU 611.

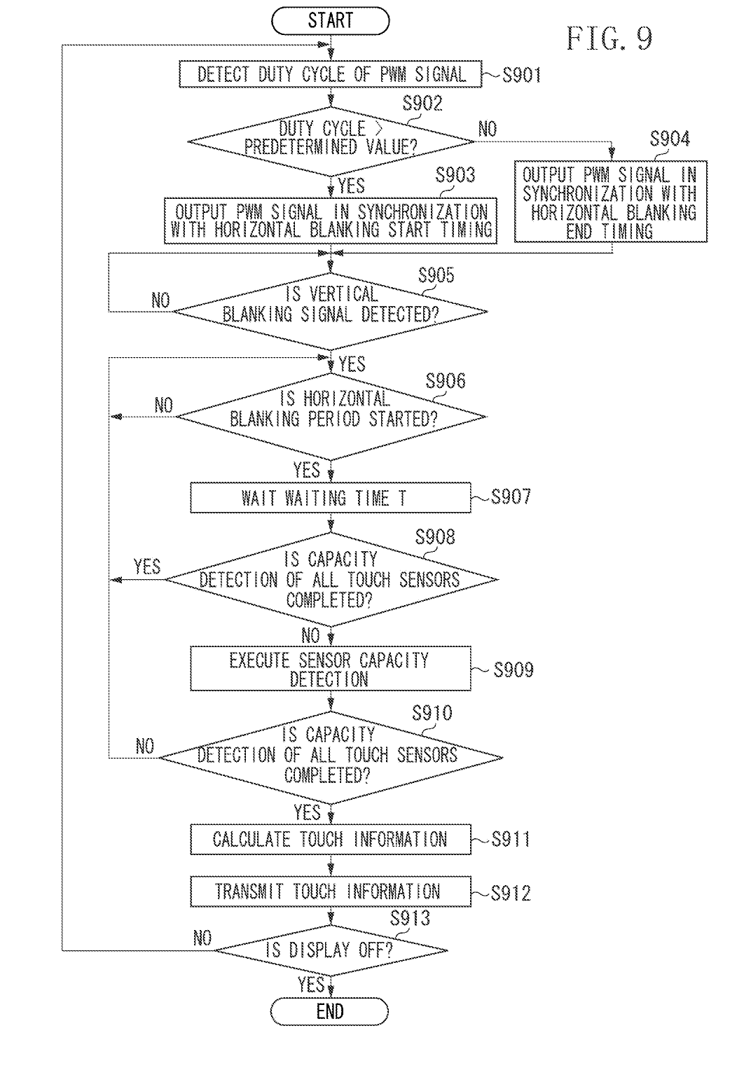

The following describes a fourth exemplary embodiment. FIG. 9 is a flow chart illustrating another operation with respect to the configuration illustrated in FIG. 6. Steps S901 to S904 are executed by the CPU 611, and steps S905 to S912 are executed by the touch panel control unit 620. The CPU 611 reads a program for realizing the processing of steps S901 to S904 from the non-volatile memory 12, loads the program into the main memory 13, and executes the program. Firmware or a program for realizing the processing of steps S905 to S912 is installed in the touch panel control unit 620. The functions of the touch panel control unit 620 can be realized by a program running on the CPU 611. In this case, the CPU 611 reads the program for realizing the processing of steps S905 to S912 from the non-volatile memory 12 and executes the program to realize the functions of the touch panel control unit 620, or loads the program into the touch panel control unit 620 to cause the touch panel control unit 620 to execute the program.

As in the third exemplary embodiment, the CPU 611 supplies the PWM signal 30 synchronized with the horizontal synchronization signal of the display synchronization signal 640 and with the same frequency as the frequency of the horizontal synchronization signal to the backlight control unit 24 to turn on the backlight 23. At the same time, the CPU 611 supplies display image data and the display synchronization signal 640 to the display control unit 22 to display images on the display 21. The CPU 611 transmits a touch detection start command to the touch panel control unit 620 via the bus 34 to change the touch panel control unit 620 to an activated state. In the activated state, the touch panel control unit 620 realizes the process illustrated in FIG. 9 under the control performed by the CPU 611.

In step S901, the CPU 611 detects the duty cycle of the PWM signal 30. In step S902, the CPU 611 determines whether the duty cycle of the PWM signal 30 detected in step S901 is less than or equal to a predetermined value. This is to determine whether the on-period of the backlight current 32 is shorter than the horizontal blanking period. If the detected duty cycle is less than or equal to the predetermined value (NO in step S902), the processing proceeds to step S904. If the detected duty cycle is greater than the predetermined value (YES in step S902), the processing proceeds to step S903.

In step S903, the CPU 611 outputs the PWM signal 30 in synchronization with the timing of the start of the horizontal blanking. In step S904, the CPU 611 outputs the PWM signal 30 in synchronization with the timing of the end of the horizontal blanking. The synchronization of the PWM signal 30 with the start or end of the horizontal blanking period as described above prevents the backlight current 32 from fluctuating from the on-state to the off-state or from the off-state to the on-state during the horizontal blanking period.

In step S905, the touch panel control unit 620 waits for a vertical blanking signal of the display synchronization signal 640. Specifically, the touch panel control unit 620 waits for a start of one-frame display processing. If a vertical blanking signal is detected (YES in step S905), the processing proceeds to step S906.

In step S906, the touch panel control unit 620 performs edge detection of the horizontal synchronization signal to wait for a start of a horizontal blanking period. If a horizontal blanking period is started (YES in step S906), the processing proceeds to step S907.

In step S907, the touch panel control unit 620 waits the predetermined time T for the backlight current 32 to be turned on or off.

In step S908, the touch panel control unit 620 determines whether the capacity detection signal 36 is transmitted to all the touch sensors of the touch panel 19 and the sensor output signal 38 is received from all the touch sensors. If the capacity detection of all the touch sensors is completed (YES in step S908), the processing returns to step S906. If the capacity detection of all the touch sensors is not completed (NO in step S908), the processing proceeds to step S909.

In step S909, the touch panel control unit 620 transmits the capacity detection signal 36 to all the touch sensors of the touch panel 19 to detect the capacities of all the touch sensors. The touch panel control unit 620 performs the capacity detection of the touch panel 19 just on a region that is detectable within the horizontal blanking period, and if the horizontal blanking ends, the capacity detection of the touch panel 19 stops.

In step S910, the touch panel control unit 620 determines whether the capacity detection signal 36 is transmitted to all the sensors of the touch panel 19 and the sensor output signal 38 is received from all the sensors. If the capacity detection of all the sensors is completed (YES in step S910), the processing proceeds to step S911. If the capacity detection of all the touch sensors is not completed (NO in step S910), the processing returns to step S906.

In step S911, the touch panel control unit 620 calculates, based on the sensor output signals 38, the presence/absence and coordinates/region of a touch.

In step S912, the touch panel control unit 620 transmits the result of the calculation performed in step S911 to the CPU 611. The CPU 611 executes control in response to the detected touch based on the data from the touch panel control unit 620.

In step S913, the touch panel control unit 620 determines whether the display on the display 21 is off based on the display synchronization signal 640 or a touch detection stop command from the CPU 611. If the display is not off (NO in step S913), the processing returns to step S901. If the display is off (YES in step S913), the process illustrated in FIG. 9 ends. In the case where the display is to be off, the CPU 611 stops the output of the display synchronization signal 640 and supplies a touch detection stop command to the touch panel control unit 620.

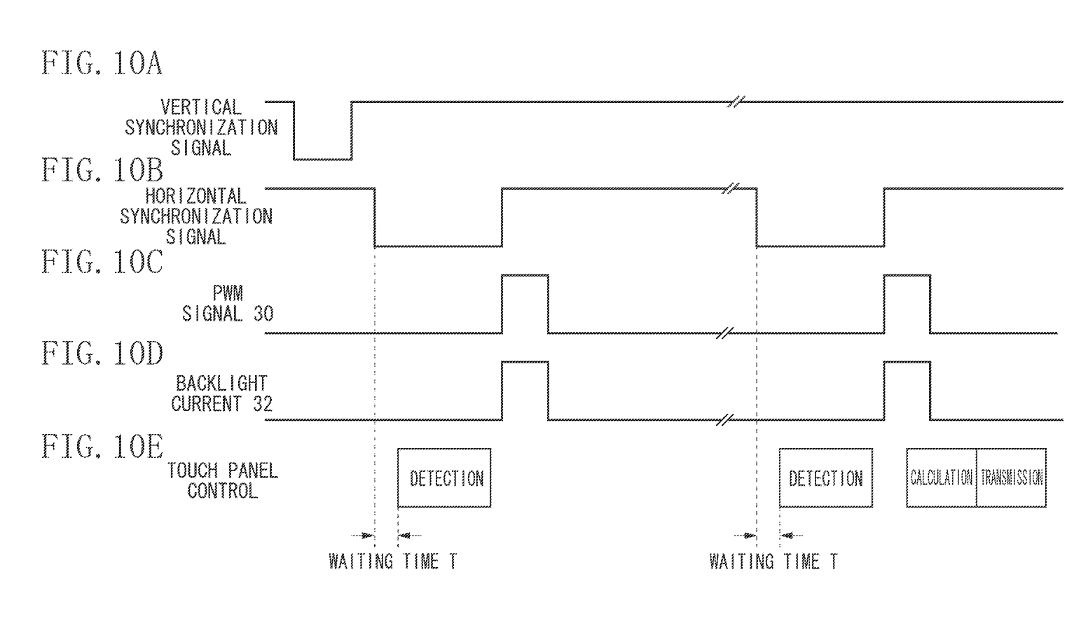

FIGS. 10A to 10E illustrate an example of the timings with respect to the capacity detection process illustrated in FIG. 9. FIG. 10A illustrates the vertical synchronization signal contained in the display synchronization signal. FIG. 10B illustrates the horizontal synchronization signal. FIG. 10C illustrates the waveform of the PWM signal 30. FIG. 10D illustrates the waveform of the backlight current 32. FIG. 10E illustrates details of the operation of the touch panel control unit 620.

The CPU 611 determines whether the on-period of the backlight current 32 is longer than or equal to the horizontal blanking period based on the duty cycle of the PWM signal 30. According to the determination result, the CPU 611 outputs the PWM signal 30 with the same frequency as the frequency of the horizontal synchronization signal (FIG. 10B) of the display synchronization signal 640, in synchronization with the horizontal synchronization signal. FIGS. 10A to 10E illustrate an example of the case where the on-period of the backlight current 32 is shorter than the horizontal blanking period.

The backlight control unit 24 supplies the backlight current 32 (FIG. 10D) synchronized with the PWM signal 30 to the backlight 23 based on the PWM signal 30 (FIG. 10C) from the CPU 611. The backlight current 32 is repeatedly turned on and off in synchronization with the PWM signal 30.

The touch panel control unit 620 detects an end of vertical blanking and a falling edge of the horizontal synchronization signal as described above. If the touch panel control unit 620 detects a start of the horizontal blanking period, the touch panel control unit 620 outputs the capacity detection signal 36 to the touch panel 19 after the predetermined time T and detects the capacity of the touch panel 19. During horizontal scans, the capacity detection of the touch panel 19 is repeatedly executed.

If the capacity detection of all the touch sensors is completed, the touch panel control unit 620 calculates the presence/absence and coordinates/region of a touch based on the sensor output signals 38 of all the touch sensors and transmits the calculation result to the CPU 611.

The touch panel control unit 620 detects a vertical blanking period for the next capacity detection of the touch panel 19. Thereafter, the touch panel control unit 620 repeats the same processing until an instruction to stop the touch detection is provided by the CPU 611.

In the present exemplary embodiment, an adjustment is made such that transitions of the backlight current 32 from the on-state to the off-state or from the off-state to the on-state do not occur during the horizontal blanking period, and then the detection of a touch operation is performed during the horizontal blanking period. In this way, the effect of noise originating from the rising and falling edges of the backlight current 32 is avoided.

In the fourth exemplary embodiment, the display control unit 22 can supply to the touch panel control unit 620 a control signal synchronized with the display synchronization signal 640 based on the display synchronization signal 640 from the CPU 611.

In FIG. 9, the determination of whether the PWM signal 30 is to be synchronized with a start or end of horizontal blanking is controlled based on the duty cycle of the PWM signal 30. Alternatively, the order of the on-period and the off-period of the PWM signal 30 can be changed based on the duty cycle of the PWM signal 30.

While the present disclosure is described in detail with reference to exemplary embodiments, it is to be understood that the disclosed exemplary embodiments are not limiting, and the scope of the disclosure encompasses various forms within the spirit of the disclosure. Each of the disclosed exemplary embodiments is a mere illustration of one exemplary embodiment and the exemplary embodiments can be combined as appropriate.

The various types of control to be performed by the CPUs 11 and 611 and the touch panel control units 20 and 620 described above can be performed by a single piece of hardware or a plurality of pieces of hardware.

While the case where the present disclosure is applied to the electronic apparatuses including the touch panel is described as an example, this example is not limiting and is applicable to various apparatuses including a touch operation input unit, such as a touch panel and the like. For example, personal computers, personal digital assistants (PDAs), mobile phone terminals, mobile image viewers, printer apparatuses, digital photo frames, music players, game apparatuses, electronic book readers, tablet terminals, smartphones, and projector apparatuses are applicable. Home appliances, in-car devices, etc. that include a touch panel are also applicable.

According to exemplary embodiments, touch operations on a touch panel are detected without being affected by noise originating from the driving of a backlight.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-177031, filed Sep. 9, 2016, which is hereby incorporated by reference herein in its entirety.

What is claimed is:

1. An electronic apparatus comprising:
a display including a backlight;
a backlight control unit configured to drive the backlight with a backlight current based on a pulse-width modulation signal;
a touch panel disposed on top of a screen of the display; and
a touch panel control unit configured to detect a touch operation on the touch panel during a predetermined period to avoid a rising timing and a falling timing of the backlight current.

2. The electronic apparatus according to claim 1, wherein the touch panel control unit detects the touch operation during an on-period or an off-period of the backlight current.

3. The electronic apparatus according to claim 1, wherein the touch panel control unit detects a duty cycle of the pulse-width-modulation signal, and in a case where the duty cycle is greater than a predetermined value, the touch panel control unit detects the touch operation during an on-period of the backlight current, and in a case where the duty cycle is less than or equal to the predetermined value, the touch panel control unit detects the touch operation during an off-period of the backlight current.

4. The electronic apparatus according to claim 3, wherein the touch panel control unit detects a rising edge and a falling edge of the pulse-width-modulation signal and starts detecting the touch operation after a predetermined time from the detected rising edge and the detected falling edge.

5. The electronic apparatus according to claim 1, wherein the pulse-width-modulation signal is synchronized with a horizontal synchronization signal of an image to be displayed on the display and has a same frequency as a frequency of the horizontal synchronization signal, and
wherein the touch panel control unit detects the touch operation in synchronization with the horizontal synchronization signal.

6. The electronic apparatus according to claim 5, wherein the touch panel control unit detects the touch operation during a horizontal blanking period according to the horizontal synchronization signal.

7. The electronic apparatus according to claim 6, wherein the touch panel control unit starts detecting the touch operation after a predetermined time from a start of the horizontal blanking period.

8. The electronic apparatus according to claim 5, further comprising a control unit configured to synchronize the pulse-width-modulation signal with a start or an end of a horizontal blanking period of the horizontal synchronization signal based on a duty cycle of the pulse-width-modulation signal.

9. The electronic apparatus according to claim 8, wherein in a case where an on-period of the pulse-width-modulation signal is shorter than the horizontal blanking period, the control unit synchronizes the pulse-width-modulation signal with the end of the horizontal blanking period, and in a case where the on-period of the pulse-width-modulation signal is longer than or equal to than the horizontal blanking period, the control unit synchronizes the pulse-width-modulation signal with the start of the horizontal blanking period.

10. A method of controlling an electronic apparatus including a display including a backlight and a touch panel disposed on top of a screen of the display, the method comprising:
driving the backlight with a backlight current according to a pulse-width-modulation signal; and
detecting a touch operation on the touch panel during a predetermined period to avoid a rising timing and a falling timing of the backlight current.

11. A non-transitory computer-readable storage medium that stores a program for causing a computer to execute a method of controlling an electronic apparatus including a display including a backlight and a touch panel disposed on top of a screen of the display, the method comprising:
driving the backlight with a backlight current based on a pulse-width-modulation signal; and
detecting a touch operation on the touch panel during a predetermined period to avoid a rising timing and a falling timing of the backlight current.
